(19) United States
(12) Patent Application Publication
(10) Pub. No.: US 2022/0146050 A1
(43) Pub. Date: May 12, 2022

(54) LIQUEFIED GAS STORAGE TANK

(71) Applicant: L'Air Liquide, Societe Anonyme pour l'Etude et l'Exploitation des Procedes Georges Claude, Paris (FR)

(72) Inventors: Nicolas JANNIN, Sassenage (FR); Jerome LOSCO, Sassenage (FR); Thomas FAYER, Sassenage (FR)

(73) Assignee: L'Air Liquide, Societe Anonyme pour l'Etude et l'Exploitation des Procedes Georges Claude, Paris (FR)

(21) Appl. No.: 17/437,749

(22) PCT Filed: Mar. 4, 2020
(86) PCT No.: PCT/FR2020/050432

§ 371 Date: Sep. 9, 2021

(30) Foreign Application Priority Data
Mar. 11, 2019 (FR) FR 1902426

(51) Int. Cl. F17C 13/02; F17C 1/12

(52) U.S. Cl. CPC F17C 13/021; F17C 1/12; F17C 2201/0119; F17C 2250/0417; F17C 2223/0161; F17C 2250/0413; F17C 2250/0491; F17C 2203/0629

(57) ABSTRACT

Tank for storing liquefied gas comprising a sealed housing defining a storage space for the liquefied gas, the housing comprising a lower end and an upper end, the tank comprising a device for measuring the level of liquid in the housing, the device for measuring the level of liquid comprising, arranged in the housing, a float and a guide for moving the float, characterized in that the guide comprises an end connected to an upper portion of the housing and a lower end connected to a lower portion of the housing, the float being mounted moveably in translation on the guide such that the float is free to slide along the guide, the device for measuring the level of liquid further comprising at least one float position sensor.

### CROSS-REFERENCE TO RELATED APPLICATIONS

This application is a § 371 of International PCT Application PCT/FR2020/050432, filed Mar. 4, 2020, which claims § 119(a) foreign priority to French patent application FR 1902426, filed Mar. 11, 2019.

### BACKGROUND

### Field of the Invention

The invention relates to a liquefied gas storage tank.

More particularly, the invention relates to a liquefied gas storage tank comprising a sealed housing delimiting a storage volume for the liquefied gas, the housing comprising a lower end and an upper end, the tank comprising a device for measuring the level of liquid in the housing, the device for measuring the level of liquid comprising, disposed in the housing, a float and a guide for the displacement of the float.

### Related Art

Depending on the gases present, it is difficult to determine the level of liquid which is really present in a liquefied gas tank. One solution consists of providing a temperature sensor (cf. FR244877). Another known solution consists of measuring the level by means of a float disposed at the end of an articulated arm (cf. for example U.S. Pat. No. 6,216,534).

However, these solutions are intrusive and either imprecise or complex and costly to put into place.

### SUMMARY OF THE INVENTION

An objective of the present invention is to eliminate some or all of the disadvantages of the prior art indicated above.

For this purpose, the tank according to the invention, which moreover is in conformity with the generic definition given thereof by the above preamble, is substantially characterized in that the guide comprises an end which is connected to an upper part of the housing, and a lower end which is connected to a lower part of the housing, the float being fitted such as to be movable in translation on the guide such that the float is free to slide along the guide, the device for measuring the level of liquid also comprising at least one sensor for the position of the float.

Furthermore, embodiments of the invention can comprise one or more of the following features:
the guide comprises a rigid shaft;
the guide is oriented in the vertical direction in the housing;
the at least one position sensor is an optical or laser detection sensor which is configured to detect the position or the distance of the float relative to a reference point;
the at least one position sensor is situated on the exterior of the housing, at the upper end and/or the lower end of the housing;
the at least one position sensor is situated plumb with, and/or at the base of the guide;
the tank comprises an outer wall which is disposed around the housing with an intermediate space containing thermal insulation;
the at least one position sensor is secured on the exterior of the volume delimited by the outer wall, in particular on the outer surface of the outer wall, i.e. outside the intermediate space containing the thermal insulation;
the housing comprises at least one window which is situated between the sensor and the float, the window being configured to permit the passage of a signal for detection of the sensor, such as an optical or laser signal;
the device for measuring the level of liquid comprises a sensor for inclination of the tank, and an electronic data storage and processing unit which is configured to correct the level measurement carried out by the at least one position sensor according to the measurement of the inclination sensor, i.e. to increase or reduce the value of level of liquid provided by the position of the float according to the angle of inclination measured by the inclination sensor.

The invention can also relate to any alternative device or method comprising any combination of the characteristics given above or below.

### BRIEF DESCRIPTION OF THE FIGURES

Other particular features and advantages will become apparent from reading the following description, provided with reference to:

FIG. 1 which represents is a schematic, partial view in cross-section, illustrating an example of a possible structure and operation of a tank according to the invention.

### DETAILED DESCRIPTION OF THE INVENTION

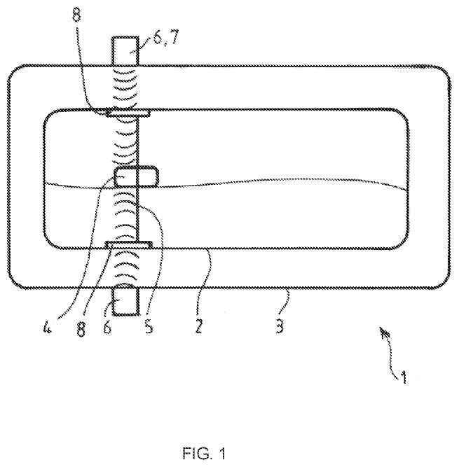

The liquefied gas storage tank 1 illustrated in FIG. 1 is a double-wall cylindrical tank comprising a sealed inner housing 2 delimiting the storage volume for the liquefied gas, and surrounded by an outer wall 3 disposed around the housing 2 with an intermediate space containing thermal insulation (a vacuum and/or thermal insulation layer(s)). It will be appreciated that the invention can be applied to any other type of tank (structure and form).

In the position of use illustrated in FIG. 1, the housing 2 comprises a lower end and an upper end.

The tank 1, and in particular the housing 2, comprises a sealed window device 8 under vacuum permitting the optical passage of a signal of at least one level sensor 6 placed on the exterior of the housing 2, in particular on the exterior of the outer wall 3. Disposed in the housing 2, this device for measuring the level of liquid comprises a float 4 and a guide 5 for the displacement of the float 4.

The guide 5 comprises an end which is connected to (secured on) an upper part of the housing 2, and a lower end which is connected to (secured on) a lower part of the housing 2. For example, the guide 5 is in a fixed position which is vertical or slightly inclined relative to the vertical.

The float 4 is fitted such as to be movable in translation on the guide 5, such that the float 4 is free to slide along the guide 5. The device for measuring the level of liquid thus additionally comprises at least one sensor 6 for the position of the float 4. In the example illustrated in FIG. 1, two sensors 6 are represented, and are situated respectively in the upper and lower parts of the outer wall 3 (on the outer surface thereof).

A second, lower sensor 6 can in particular be placed in opposition to the other, upper sensor, in order to improve the precision of the measurement, and to ensure redundancy for example (or conversely).

It will be appreciated that a single sensor 6 can be sufficient, or more than two sensors can be provided for purposes of redundancy or increased precision. The float 4, which can be in conformity with the known floats, is configured to be compatible with the type of fluid and the level of temperature and pressure present in the housing 2.

In order to float, the float 4 has dimensions such as to have a density lower than the cryogenic fluid (and a density higher than the gas). As a variant, a detectable structure can be associated with (assembled on) a floating structure. For example, the float comprises a metal sphere which is filled with gas under pressure (or under vacuum), and ensures that the float floats.

The float 4 is preferably placed in the housing 2, such that it is subjected to the movements of the free surface of the liquid only to a lesser extent. This can be optimised for example according to the geometry of the tank 1.

The float 4 is guided on a guide which can be a rigid shaft such as a rail, or a metal cable for example. This float 4 (or a plurality of floats if necessary) is coupled to at least one level sensor 6. This sensor 6 or these sensors will preferably use laser technology or any other appropriate technology with a sufficient capacity.

The sensor(s) 6 can be placed on the outer face of the upper wall of the outer wall 3, i.e. on the exterior of the volume which contains the insulation. The sensor 6 will thus detect the float 4 through sealed windows 8. These windows 8 can be constituted by a local modification of the nature of the material of the sealed housing 2. For example, a window 8 made of sapphire (or an equivalent material) which does not allow infra-red radiation to pass, is inserted in a sealed manner in an opening in the wall 2. For example, the window 8 is fitted on a flange which is secured in the wall 2.

Preferably, the sensor(s) 6 is/are not disposed in the inter-wall space 2, 3.

Another appropriate sensor 6 technology can be used (ultrasound, induction).

The float 4 can be equipped with a flat surface or another surface which is perpendicular to the axis of propagation of the measurement waves of the sensor(s) 6.

In this configuration, the float 4 is guided in translation along the guide shaft 5 which coincides with the main direction of propagation of the measurement or detection of the sensor(s) 6.

The measurement processing of the sensor(s) 6 can be associated with a detector 7 for inclination of the tank 1, in order to correct the measurement of height (and thus of the quantity) of liquid in the tank.

The measurement processing of the sensor(s) 6, 7 can advantageously be averaged in order not to take into account the noise caused for example by the movement of the free surface of the liquid.

This simple and inexpensive solution permits efficient measurement of the height of the liquid.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fail within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context dearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-6. (canceled)

7. A liquefied gas storage tank comprising an sealed housing, a device for measuring a level of liquid in the housing, and an outer wall disposed around the housing, wherein:
the housing delimits a storage volume for the liquefied gas and has a lower end and an upper end;
the device for measuring the level of liquid is disposed in the housing and comprises a float, a guide for the displacement of the float, and at least one sensor sensing the position of the float;
the guide comprises an end which is connected to an upper part of the housing and a lower end which is connected to a lower part of the housing;
the float is fitted such as to be translationally movable on the guide such that the float is free to slide along the guide;
the outer wall has an intermediate space containing thermal insulation;
the at least one position sensor is secured on an exterior of a volume delimited by the outer wall and the housing,
and in that the at least one position sensor is an optical or laser detection sensor which is configured to detect the position or the distance of the float relative to a reference point, and in that the housing comprises at least one window which is situated between the sensor and the float, the window being configured to permit the passage of a signal for detection of the sensor, such as an optical or laser signal.

8. The tank of claim 7, wherein the at least one position sensor is secured on an outer surface of the outer wall and outside the intermediate space.

9. The tank of claim 7, wherein the guide comprises a rigid shaft.

10. The tank of claim 7, wherein the guide is oriented in a vertical direction in the housing.

11. The tank of claim 7, wherein the at least one position sensor is situated on an exterior of the housing at the upper end and/or the lower end of the housing.

12. The tank of claim 7, wherein the at least one position sensor is situated plumb with, and/or at, a base of the guide.

13. The tank of claim 7, wherein the device for measuring the level of liquid comprises a sensor for inclination of the tank and an electronic data storage and processing unit, the electronic data storage and processing unit being configured to correct the level sensed by the at least one position sensor according to a measurement of the inclination sensor.

14. The tank of claim 7, wherein the device for measuring the level of liquid comprises a sensor for measuring an inclination of the tank and an electronic data storage and processing unit, the electronic data storage and processing unit being configured to correct the level sensed by the at least one position sensor by increasing or reducing a value of a level of liquid that is provided by the sensed position of the float according to an angle of inclination measured by the inclination sensor.
